(19) United States
(12) Patent Application Publication
(10) Pub. No.: US 2023/0305327 A1
(43) Pub. Date: Sep. 28, 2023

(54) OPTICAL DEVICE, OPTICAL MODULATOR, AND OPTICAL COMMUNICATION APPARATUS

(71) Applicant: Fujitsu Optical Components Limited, Kawasaki-shi (JP)

(72) Inventor: Masaki SUGIYAMA, Kawasaki (JP)

(73) Assignee: Fujitsu Optical Components Limited, Kawasaki-shi (JP)

(21) Appl. No.: 18/145,141

(22) Filed: Dec. 22, 2022

(30) Foreign Application Priority Data
Mar. 23, 2022 (JP) 2022-046434

(51) Int. Cl. G02F 1/065; G02F 1/025; H04B 10/50

(52) U.S. Cl. CPC G02F 1/065; G02F 1/025; H04B 10/501; G02F 2201/12

(57) ABSTRACT

An optical device includes a slot waveguide, and an electrode that has a coplanar structure including a signal electrode and a ground electrode disposed parallel to the slot waveguide. Furthermore, the optical device includes a plurality of electro-optical polymers each of which is inserted into a slot provided in the slot waveguide in a split state, and a bridge that is disposed in a boundary region located between the split electro-optical polymers and that electrically connects the ground electrode and another ground electrode.

### CROSS-REFERENCE TO RELATED APPLICATION

This application is based upon and claims the benefit of priority of the prior Japanese Patent Application No. 2022-046434, filed on Mar. 23, 2022, the entire contents of which are incorporated herein by reference.

### FIELD

The embodiments discussed herein are related to an optical device, an optical modulator, and an optical communication apparatus.

### BACKGROUND

FIG. 19 is a schematic plan view illustrating an example of an optical modulator 100 that is conventionally used. The optical modulator 100 illustrated in FIG. 19 includes an optical waveguide 101, and an electrode 102 that has a coplanar structure (coplanar waveguide: CPW) including a signal electrode and a ground electrode. The optical waveguide 101 is a PN junction optical waveguide constituted of N doped silicon 105A (hereinafter, simply referred to as doped Si) and P doped Si 105B. The optical waveguide 101 includes an input portion 101A, a branching portion 101B, two waveguides 101C, a multiplexing portion 101D, and an output portion 101E. The input portion 101A is an input portion of an optical modulator that inputs light to the optical modulator 100. The branching portion 101B optically branches the light received from the input portion 101A, and outputs the branched light to the two waveguides 101C. Each of the two waveguides 101C is an arm of the optical modulator that guides the light received from the branching portion 101B and that acts on the propagating light in accordance with an electric field between the electrodes 102. The multiplexing portion 101D multiplexes the light received from the two waveguides 101C, and outputs the multiplexed light. The output portion 101E is an output portion of the optical modulator 100 that outputs the light received from the multiplexing portion 101D.

The electrode 102 is an electrode that has a coplanar structure and that includes a first ground electrode 102A1, a first signal electrode 102B1, a second ground electrode 102A2, a second signal electrode 102B2, and a third ground electrode 102A3.

The first signal electrode 102B1 is disposed between the first ground electrode 102A1 and the second ground electrode 102A2 in a state parallel to these electrodes. The second signal electrode 102B2 is disposed between the second ground electrode 102A2 and the third ground electrode 102A3 in a state parallel to these electrodes.

Between the two waveguides 101C, a first waveguide 101C1 is an optical waveguide that is disposed at a lower part of a region located between the first ground electrode 102A1 and the first signal electrode 102B1. Between the two waveguides 101C, a second waveguide 101C2 is an optical waveguide that is disposed at a lower part of a region between the second signal electrode 102B2 and the third ground electrode 102A3.

In the case where the optical modulator 100 performs high-speed modulation, a high-frequency drive voltage having a band of, for example, a several tens of gigahertz (GHz) is consequently input to the first and the second signal electrodes 102B1 and 102B2, respectively, that are disposed along the waveguide 101C.

FIG. 20 is a schematic cross-sectional diagram taken along line M-M illustrated in FIG. 19. The schematic cross-sectional region taken along line M-M illustrated in FIG. 20 includes a silicon substrate 131, an intermediate layer 132 that is made of SiO₂ and that is laminated on the silicon substrate 131, and the optical waveguide 101 that is formed on the intermediate layer 132. Furthermore, the schematic cross-sectional region includes a buffer layer 133 that is made of SiO₂ and that is laminated on the intermediate layer 132 including the optical waveguide 101, and the electrode 102. In addition, the electrode 102 includes the first ground electrode 102A1, the first signal electrode 102B1, and the second ground electrode 102A2.

The buffer layer 133 has a structure in which a via 106 is formed between the first ground electrode 102A1 and the N doped Si 105A that constitutes the first waveguide 101C1, and includes a region that joins a portion between the first ground electrode 102A1 and the N doped Si 105A that constitutes the first waveguide 101C1 by way of the via 106. The buffer layer 133 has a structure in which the via 106 is formed between the first signal electrode 102B1 and the P doped Si 105B that constitutes the first waveguide 101C1, and includes a region that joins a portion between the first signal electrode 102B1 and the P doped Si 105B that constitutes the first waveguide 101C1 by way of the via 106.

Furthermore, although not illustrated, the buffer layer 133 includes the via 106 that is formed between the third ground electrode 102A3 and the N doped Si 105A that constitutes the second waveguide 101C2. The via 106 is a region that joins a portion between the third ground electrode 102A3 and the N doped Si 105A that constitutes the second waveguide 101C2. Furthermore, the buffer layer 133 includes the via 106 that is formed between the second signal electrode 102B2 and the P doped Si 105B that constitutes the second waveguide 101C2. The via 106 is a region that joins a portion between the second signal electrode 102B2 and the P doped Si 105B that constitutes the second waveguide 101C2.

In the optical modulator 100, when a high-frequency drive voltage is applied to the first signal electrode 102B1, a carrier density of the PN junction of the first waveguide 101C1 located between the first signal electrode 102B1 and the first ground electrode 102A1 is changed. In the optical modulator 100, the phase of light propagating through the first waveguide 101C1 is changed as a result of a change in the refractive index of the first waveguide 101C1 in accordance with a change in the carrier density. Similarly, in the optical modulator 100, when a high-frequency drive voltage is applied to the second signal electrode 102B2, a carrier density of the PN junction of the second waveguide 101C2 located between the second signal electrode 102B2 and the third ground electrode 102A3 is changed. In the optical modulator 100, the phase of the light propagating through the second waveguide 101C2 is changed as a result of a change in the refractive index of the second waveguide 101C2 in accordance with a change in the carrier density. Consequently, by multiplexing, by using the multiplexing portion 101D, the light received from the first waveguide 101C1 subjected to phase modulation and the light received from the second waveguide 101C2 subjected to phase modulation, the optical modulator 100 is able to perform conversion, such as a change in light intensity at multilevel in accordance with a phase difference of the light.
Patent Document 1: U.S. Patent Application Publication No. 2014/0086523
Patent Document 2: Japanese Laid-open Patent Publication No. 2021-43263
Patent Document 3: U.S. patent Ser. No. 10/962,811

However, the optical waveguide 101 included in the conventional optical modulator 100 is constituted of a silicon PN junction; therefore, a change in the refractive index of light is small, and the drive voltage applied to the first signal electrode 102B1 and the second signal electrode 102B2 is large, and thus, electric power consumption is increased.

### SUMMARY

According to an aspect of an embodiment, an optical device includes a slot waveguide, an electrode, a plurality of electro-optical polymers and a bridge. The electrode has a coplanar structure including a signal electrode and a ground electrode disposed parallel to the slot waveguide. Each of the plurality of electro-optical polymers is inserted into a slot provided in the slot waveguide in a split state. The bridge is disposed in a boundary region located between the split electro-optical polymers and electrically connects the ground electrode and another ground electrode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to a present embodiment;

FIG. 2 is a schematic plan view illustrating an example of a configuration of an optical modulator according to a first embodiment;

FIG. 3 is a schematic cross-sectional diagram taken along line A-A illustrated in FIG. 2;

FIG. 4 is a schematic cross-sectional diagram taken along line B-B illustrated in FIG. 2;

FIG. 5 is a schematic plan view illustrating an example of a configuration of an optical modulator according to a second embodiment;

FIG. 6 is a schematic cross-sectional diagram taken along line C-C illustrated in FIG. 5;

FIG. 7 is a schematic cross-sectional diagram taken along line D-D illustrated in FIG. 5;

FIG. 8 is a schematic plan view illustrating an example of a configuration of an optical modulator according to a third embodiment;

FIG. 9 is a schematic cross-sectional diagram taken along line E-E illustrated in FIG. 8;

FIG. 10 is a schematic cross-sectional diagram taken along line F-F illustrated in FIG. 8;

FIG. 11 is a schematic plan view illustrating an example of a configuration of an optical modulator according to a fourth embodiment;

FIG. 12 is a schematic cross-sectional diagram taken along line G-G illustrated in FIG. 11;

FIG. 13 is a schematic cross-sectional diagram taken along line H-H illustrated in FIG. 11;

FIG. 14 is a schematic plan view illustrating an example of a configuration of an optical modulator according to a fifth embodiment;

FIG. 15 is a schematic cross-sectional diagram taken along line J-J illustrated in FIG. 14;

FIG. 16 is a schematic cross-sectional diagram taken along line K-K illustrated in FIG. 14;

FIG. 17 is a schematic plan view illustrating an example of a configuration of an optical modulator according to a comparative example;

FIG. 18 is a schematic cross-sectional diagram taken along line L-L illustrated in FIG. 17;

FIG. 19 is a schematic plan view illustrating an example of a configuration of a conventional optical modulator; and

FIG. 20 is a schematic cross-sectional diagram taken along line M-M illustrated in FIG. 19.

### DESCRIPTION OF EMBODIMENTS

### Comparative Example

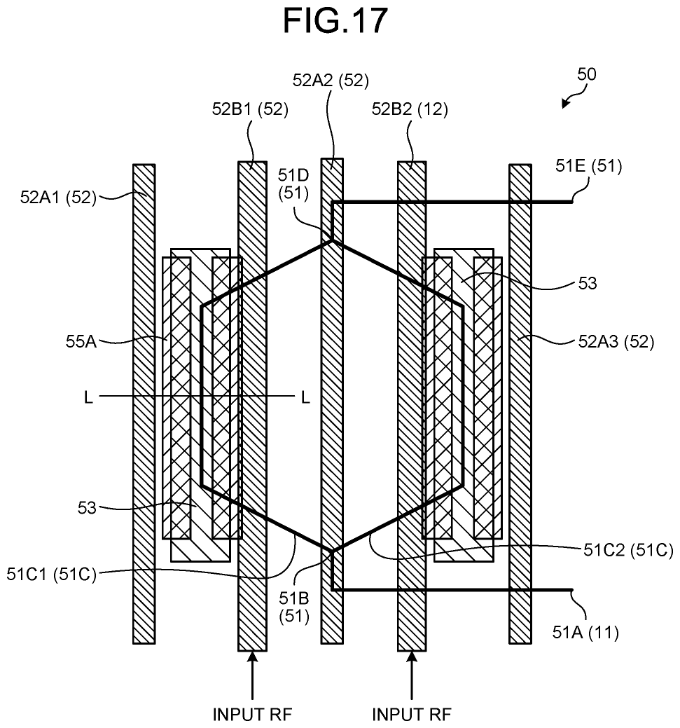

In an optical modulator, it is conceivable to use an optical waveguide provided with an EO polymer instead of an optical waveguide made of silicon using a PN junction in order to suppress a drive voltage applied to a first signal electrode and a second signal electrode. FIG. 17 is a schematic plan view illustrating an example of a configuration of an optical modulator 50 according to a comparative example.

The optical modulator 50 according to the comparative example illustrated in FIG. 17 includes an optical waveguide 51, and an electrode 52 that has a coplanar structure including a signal electrode and a ground electrode. The optical waveguide 51 is a slot waveguide constituted of two pieces of N doped Si 55A. The optical waveguide 51 includes an input portion 51A, a branching portion 51B, two waveguides 51C, a multiplexing portion 51D, and an output portion 51E. The input portion 51A is an input portion of the optical modulator 50 that inputs light to the optical modulator 50. The branching portion 51B optically branch the light received from the input portion 51A and outputs the branched light to the two waveguides 51C. Each of the two waveguides 51C is an arm of the optical modulator 50 that guides the light received from the branching portion 51B and that acts on the propagating light in accordance with an electric field between the electrodes 52. The multiplexing portion 51D multiplexes the branched light received from the two waveguides 51C and outputs the multiplexed light. The output portion 51E is an output portion of the optical modulator 50 that outputs the light received from the multiplexing portion 51D.

The electrode 52 is an electrode that has a coplanar structure including a first ground electrode 52A1, a first signal electrode 52B1, a second ground electrode 52A2, a second signal electrode 52B2, and a third ground electrode 52A3. The first signal electrode 52B1 is disposed between the first ground electrode 52A1 and the second ground electrode 52A2 in a state parallel to these electrodes. The second signal electrode 52B2 is disposed between the second ground electrode 52A2 and the third ground electrode 52A3 in a state parallel to these electrodes.

Between the two waveguides 51C, a first waveguide 51C1 is an optical waveguide that is disposed at a lower part of a region located between the first ground electrode 52A1 and the first signal electrode 52B1. The first waveguide 51C1 is a slot waveguide provided with a slot 55B that is constituted of the two pieces of N doped Si 55A.

Between the two waveguides 51C, a second waveguide 51C2 is an optical waveguide that is disposed at a lower part of a region located between the second signal electrode 52B2 and the third ground electrode 52A3. The second waveguide 51C2 is a slot waveguide provided with the slot 55B that is constituted of the two pieces of N doped Si 55A.

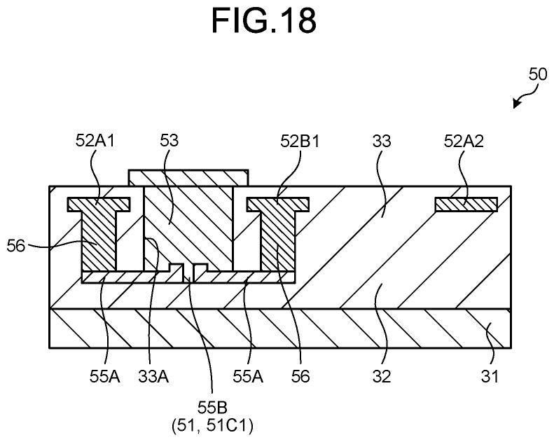

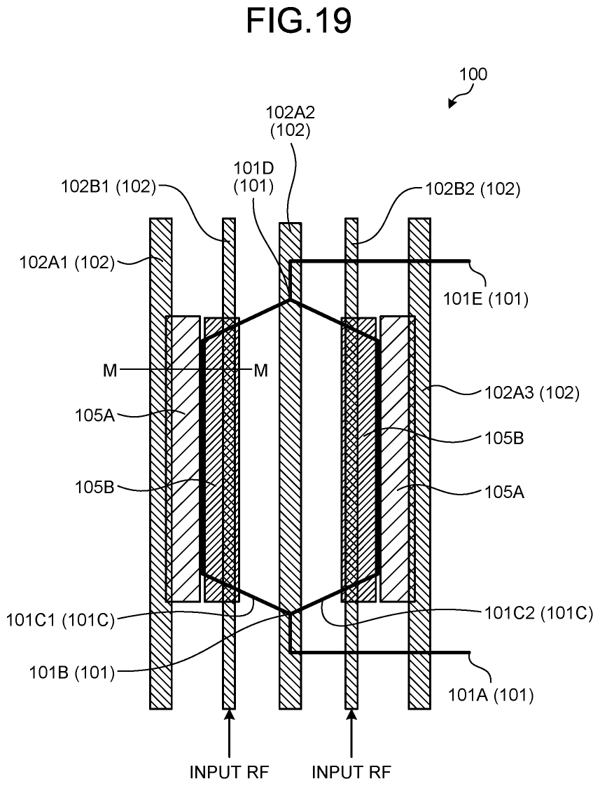

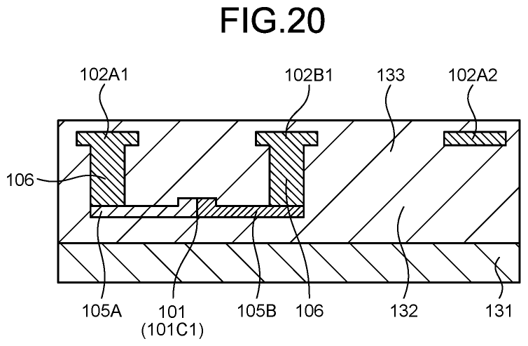

FIG. 18 is a schematic cross-sectional diagram taken along line L-L illustrated in FIG. 17. The schematic cross-sectional region taken along line L-L illustrated in FIG. 18 includes a silicon substrate 31, an intermediate layer 32 that is made of SiO₂ and that is laminated on the silicon substrate 31, the optical waveguide 51 that is formed on the intermediate layer 32, a buffer layer 33 that is made of SiO₂ and that is laminated on the intermediate layer 32 including the optical waveguide 51, and the electrode 52. In addition, the electrode 52 includes the first ground electrode 52A1, the first signal electrode 52B1, and the second ground electrode 52A2.

The buffer layer 33 includes a via 56 that is formed between the first ground electrode 52A1 and the N doped Si 55A that constitutes the first waveguide 51C1. The via 56 joins a portion between the first ground electrode 52A1 and the N doped Si 55A that constitutes the first waveguide 51C1. The buffer layer 33 includes the via 56 that is formed between the first signal electrode 52B1 and the N doped Si 55A that constitutes the first waveguide 51C1. The via 56 joins a portion between the first signal electrode 52B1 and the N doped Si 55A that constitutes the first waveguide 51C1. Furthermore, the buffer layer 33 includes an opening portion 33A that is formed between the first ground electrode 52A1 and the first signal electrode 52B1. An electro-optical (EO) polymer 53 is accordingly disposed on the N doped Si 55A provided in the first waveguide 51C1 in order to fill the slot 55B located between the N doped Si 55A provided in the first waveguide 51C1 with a part of the electro-optical (EO) polymer 53 disposed in the opening portion 33A.

The buffer layer 33 includes the via 56 that is formed between the third ground electrode 52A3 and the N doped Si 55A that is included in the second waveguide 51C2. The via 56 joins a portion between the third ground electrode 52A3 and the N doped Si 55A that is included in the second waveguide 51C2. The buffer layer 33 includes the via 56 that is formed between the second signal electrode 52B2 and the N doped Si 55A that is included in the second waveguide 51C2. The via 56 joins a portion between the second signal electrode 52B2 and the N doped Si 55A that is included in the second waveguide 51C2. Furthermore, the buffer layer 33 includes the opening portion 33A that is formed between the third ground electrode 52A3 and the second signal electrode 52B2. The EO polymer 53 is accordingly disposed on the N doped Si 55A provided in the second waveguide 51C2 in order to fill the slot 55B located between the two pieces of N doped Si 55A provided in the second waveguide 51C2 with a part of the EO polymer 53 disposed in the opening portion 33A.

Regarding the optical modulator 50, the EO polymer 53 is used in the slot 55B provided in the optical waveguide 51, so that a change in the refractive index of light propagating through the optical waveguide 51 is increased. In addition, in the optical modulator 50, when a high-frequency drive voltage is applied to the first signal electrode 52B1, the phase of the light propagating through the first waveguide 51C1 is changed as a result of a change in the refractive index of the first waveguide 51C1 located between the first signal electrode 52B1 and the first ground electrode 52A1. Similarly, in the optical modulator 50, when a high-frequency drive voltage is applied to the second signal electrode 52B2, the phase of the light propagating through the second waveguide 51C2 is changed as a result of a change in the refractive index of the second waveguide 51C2 located between the second signal electrode 52B2 and the third ground electrode 52A3. Consequently, by multiplexing, by using the multiplexing portion 51D, the light that has been subjected to phase modulation received from the first waveguide 51C1 and the light that has been subjected to phase modulation received from the second waveguide 51C2, the optical modulator 50 is able to perform conversion, such as a change in light intensity at multilevel in accordance with a phase difference of the light.

In the optical modulator 50 according to the comparative example, the EO polymer 53 is used in the slot 55B provided in the optical waveguide 51, so that a change in the refractive index of the light propagating through the optical waveguide 51 is increased. Consequently, it is possible to decrease the drive voltage applied to the first signal electrode 52B1 and the second signal electrode 52B2, and it is thus possible to suppress electric power consumption.

In the optical modulator 50 according to the comparative example, in order to fill the slot 55B located between the two pieces of N doped Si 55A provided in the optical waveguide 51 with the EO polymer 53, there is a need to etch the opening portion 33A in the buffer layer 33 and inject the EO polymer 53 into the opening portion 33A. In addition, in the optical modulator 50 according to the comparative example, in order to provide the opening portion 33A in the buffer layer 33 located between the first ground electrode 52A1 and the first signal electrode 52B1, the first ground electrode 52A1 and the first signal electrode 52B1 need to be placed at an interval.

However, in the optical modulator 50 according to the comparative example, when the interval between the first ground electrode 52A1 and the first signal electrode 52B1 is made longer, the distance between the first ground electrode 52A1 and the first signal electrode 52B1 is increased. Therefore, the electric potentials of the first ground electrode 52A1 and the second ground electrode 52A2 located at both sides of the first signal electrode 52B1 become unstable at a high frequency. Similarly, in the optical modulator 50 according to the comparative example, when the interval between the third ground electrode 52A3 and the second signal electrode 52B2 is made longer, the distance between the third ground electrode 52A3 and the second signal electrode 52B2 is increased. Therefore, the electric potentials of the second ground electrode 52A2 and the third ground electrode 52A3 located at both sides of the second signal electrode 52B2 become unstable at a high frequency. In other words, in the optical modulator 50 according to the comparative example, when the interval between the ground electrode and the signal electrode is made longer, the electric potentials between the ground electrodes located at both sides of the signal electrode become unstable at a high frequency, thus resulting in degradation of the characteristic of the high frequency band.

For example, when a high-frequency drive voltage having a band of a several tens of gigahertz (GHz) is applied to the signal electrode, the phase is changed as a result of a variation in the electric potential applied at an input stage of the waveguide 51C, and thus, the degree of change is increased in accordance with a propagation distance of the electrical signal (electric field). At the input stage of the waveguide 11C, even if the electric potentials are the same between the ground electrodes located at both sides, a difference occurs between the electric potentials in accordance with the propagation distance of the electrical signal (electric field). Consequently, when the interval between the signal electrode and the ground electrode is increased, the electric potentials of the ground electrodes located at both sides of the signal electrode become unstable at a high frequency. When the electric potentials of the ground electrodes located at both sides become unstable at a high frequency, a voltage between the signal electrode and the ground electrode is decreased, and the voltage applied to the waveguide 11C is accordingly decreased. Consequently, the modulation efficiency at a high frequency is decreased, thus resulting in degradation of the characteristic of the high frequency band.

Therefore, an embodiment of an optical modulator that is able to suppress characteristic degradation at a high frequency band by preventing a decrease in the modulation efficiency at a high frequency while stabilizing the electric potentials between the ground electrodes located at both sides of the signal electrode even if the EO polymer is used will be described as a first embodiment. Furthermore, the present invention is not limited to the embodiment.

### [a] First Embodiment

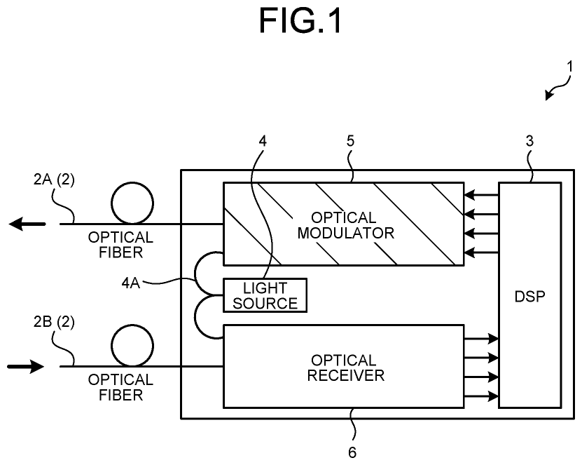

FIG. 1 is a block diagram illustrating an example of a configuration of an optical communication apparatus 1 according to the present embodiment. The optical communication apparatus 1 illustrated in FIG. 1 is connected to an optical fiber 2A (2) disposed on an output side and an optical fiber 2B (2) disposed on an input side. The optical communication apparatus 1 includes a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, generates an electrical signal including the transmission data, and outputs the generated electrical signal to the optical modulator 5. Furthermore, the DSP 3 acquires an electrical signal including reception data from the optical receiver 6, and obtains reception data by performing a process of, for example, decoding the acquired electrical signal.

The light source 4 includes, for example, a laser diode or the like, generates light with a predetermined wavelength, and supplies the generated light to the optical modulator 5 and the optical receiver 6 through a connect fiber 4A. The optical modulator 5 is an optical device that modulates, by using the electrical signal that is output from the DSP 3, the light supplied from the light source 4, and that outputs the obtained optical transmission signal to the optical fiber 2A. The optical modulator 5 is an optical device, such as an Si optical modulator, that includes, for example, an optical waveguide 11 and an electrode 12 having a coplanar (coplanar waveguide: CPW) structure. The optical waveguide 11 is formed on a Si crystal substrate. The optical modulator 5 generates the optical transmission signal by modulating, at the time of light supplied from the light source 4 passing through the optical waveguide 11, the light by the electrical signal that is input to the signal electrode included in the electrode 12.

The optical receiver 6 receives an optical signal from the optical fiber 2B, and demodulates the received optical signal by using the light supplied from the light source 4. Then, the optical receiver 6 converts the received demodulated optical signal to an electrical signal, and outputs the converted electrical signal to the DSP 3.

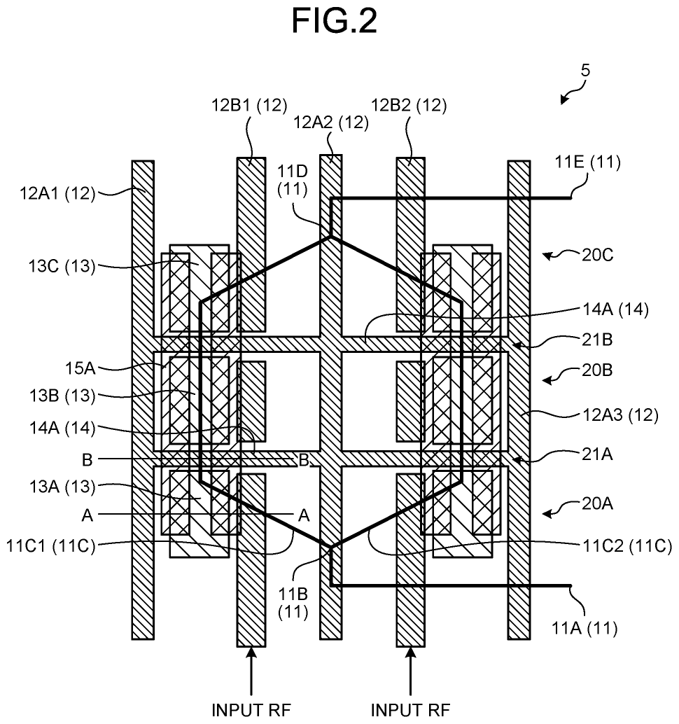

FIG. 2 is a schematic plan view illustrating an example of a configuration of the optical modulator 5 according to the first embodiment. The optical modulator 5 illustrated in FIG. 2 includes the optical waveguide 11, the electrode 12 that has a coplanar structure, that includes a signal electrode and a ground electrode, and that is disposed parallel to the optical waveguide 11, and a plurality of EO polymers 13 inserted into a slot 15B provided in the optical waveguide 11 in a split state. Furthermore, the optical modulator 5 is disposed in a first boundary region 21A that is located between the split EO polymers, and includes a bridge 14 that electrically connects the ground electrode and another ground electrode.

The optical waveguide 11 is a slot waveguide constituted of two pieces of N doped Si 15A. The optical waveguide 11 includes an input portion 11A, a branching portion 11B, two waveguides 11C, a multiplexing portion 11D, and an output portion 11E. The input portion 11A is an input portion of the optical modulator 5 that inputs light received from the light source 4. The branching portion 11B optically branches the light received from the input portion 11A, and outputs the branched light to the two waveguides 11C. Each of the two waveguides 11C is an arm of the optical modulator 5 that propagates the light received from the branching portion 11B and that acts on the propagating light in accordance with the electric field between the electrodes 12. The multiplexing portion 11D multiplexes the branched light received from the two waveguides 11C, and outputs the multiplexed light. The output portion 11E is an output portion of the optical modulator 5 that outputs the light received from the multiplexing portion 11D.

The electrode 12 is constituted by using a material made of, for example, aluminum, gold, silver, copper, or the like. The electrode 12 is an electrode having a coplanar structure including a first ground electrode 12A1, a first signal electrode 12B1, a second ground electrode 12A2, a second signal electrode 12B2, and a third ground electrode 12A3. The first signal electrode 12B1 is disposed between the first ground electrode 12A1 and the second ground electrode 12A2 in a state parallel to these electrodes. The second signal electrode 12B2 is disposed between the second ground electrode 12A2 and the third ground electrode 12A3 in a state parallel to these electrodes.

Between the two waveguides 11C, a first waveguide 11C1 is an optical waveguide that is disposed in a lower part of the region located between the first ground electrode 12A1 and the first signal electrode 12B1. The first waveguide 11C1 is a slot waveguide that is provided with the slot 15B constituted of the two pieces of N doped Si 15A.

Between the two waveguides 11C, a second waveguide 11C2 is an optical waveguide that is disposed in a lower part of the region located between the second signal electrode 12B2 and the third ground electrode 12A3. The second waveguide 11C2 is a slot waveguide that is provided with the slot 15B constituted of the two pieces of N doped Si 15A.

The optical modulator 5 includes a first region 20A located in the travelling direction of light passing through the optical waveguide 11, a second region 20B located in the travelling direction of light passing through the optical waveguide 11, and a third region 20C located in the travelling direction of light passing through the optical waveguide 11. The optical modulator 5 includes the first boundary region 21A that is a boundary region and that is located between the first region 20A and the second region 20B, and a second boundary region 21B that is a boundary region and that is located between the second region 20B and the third region 20C.

In the optical modulator 5, in accordance with the travelling direction of the light passing through the optical waveguide 11, the light passes through the waveguide 11C from the first region 20A toward the first boundary region 21A, the second region 20B, the second boundary region 21B, and the third region 20C in this order.

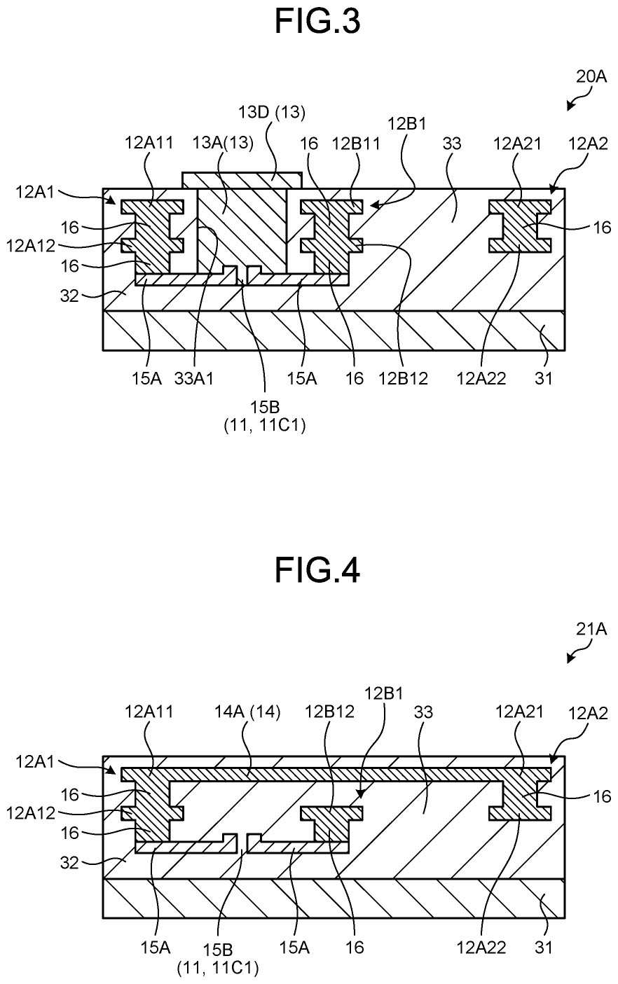

FIG. 3 is a schematic cross-sectional diagram taken along line A-A illustrated in FIG. 2. The schematic cross-sectional region taken along line A-A illustrated in FIG. 3 is the first region 20A located on, for example, the first waveguide 11C1 side. The first region 20A includes the silicon substrate 31, the intermediate layer 32 that is made of SiO₂ and that is laminated on the silicon substrate 31, the optical waveguide 11 that is formed on the intermediate layer 32, the buffer layer 33 that is made of SiO₂ and that is laminated on the intermediate layer 32 including the optical waveguide 11, and the electrode 12. In addition, the electrode 12 includes the first ground electrode 12A1, the first signal electrode 12B1, and the second ground electrode 12A2.

The electrode 12 includes a first layer M1, and a second layer M2 that is disposed at a lower portion of the first layer M1. The first ground electrode 12A1 includes a region 12A11 located in the first layer M1, and a region 12A12 located in the second layer M2. The second ground electrode 12A2 includes a region 12A21 located in the first layer M1, and a region 12A22 located in the second layer M2. The first signal electrode 12B1 includes a region 12B11 located in the first layer M1, and a region 12B12 located in the second layer M2.

A portion between the region 12A11 located in the first layer M1 included in the first ground electrode 12A1 and the region 12A12 located in the second layer M2 included in the first ground electrode 12A1 is joined by a via 16, and a portion between the region 12A12 located in the second layer M2 included in the first ground electrode 12A1 and the N doped Si 15A is joined by the via 16. A portion between the region 12B11 located in the first layer M1 included in the first signal electrode 12B1 and the region 12B12 located in the second layer M2 included in the first signal electrode 12B1 is joined by the via 16, and a portion between the region 12B12 located in the second layer M2 included in the first signal electrode 12B1 and the N doped Si 15A is joined by the via 16. A portion between the region 12A21 located in the first layer M1 included in the second ground electrode 12A2 and the region 12A22 located in the second layer M2 included in the second ground electrode 12A2 is joined by the via 16.

The first region 20A on the first waveguide 11C1 side includes an opening portion 33A1 that is formed in the buffer layer 33 located between the first ground electrode 12A1 and the first signal electrode 12B1, and a first EO polymer 13A that is inserted into the opening portion 33A1. The first waveguide 11C1 is in a state in which a part of the first EO polymer 13A is inserted into the slot 15B. In addition, the EO polymer is accordingly inserted into the opening portion 33A1 by using, for example, a dispenser.

The first region 20A on the second waveguide 11C2 side includes the second ground electrode 12A2, the second signal electrode 12B2, and the third ground electrode 12A3. The first region 20A on the second waveguide 11C2 side includes the opening portion 33A1 that is formed in the buffer layer 33 located between the third ground electrode 12A3 and the second signal electrode 12B2, and the first EO polymer 13A that is inserted into the opening portion 33A1. The second waveguide 11C2 is in a state in which a part of the first EO polymer 13A is inserted into the slot 15B.

The second region 20B on the first waveguide 11C1 side includes the first ground electrode 12A1, the first signal electrode 12B1, and the second ground electrode 12A2. The second region 20B on the first waveguide 11C1 side includes the opening portion 33A1 that is formed in the buffer layer 33 located between the first ground electrode 12A1 and the first signal electrode 12B1, and a second EO polymer 13B that is inserted into the opening portion 33A1. The first waveguide 11C1 is in a state in which a part of the second EO polymer 13B is inserted into the slot 15B.

The second region 20B on the second waveguide 11C2 side includes the second ground electrode 12A2, the second signal electrode 12B2, and the third ground electrode 12A3. The second region 20B on the second waveguide 11C2 side includes the opening portion 33A1 that is formed in the buffer layer 33 located between the third ground electrode 12A3 and the second signal electrode 12B2, and the second EO polymer 13B that is inserted into the opening portion 33A1. The second waveguide 11C2 is in a state in which a part of the second EO polymer 13B is inserted into the slot 15B.

The third region 20C on the first waveguide 11C1 side includes the first ground electrode 12A1, the first signal electrode 12B1, and the second ground electrode 12A2. The third region 20C on the first waveguide 11C1 side includes the opening portion 33A1 that is formed in the buffer layer 33 located between the first ground electrode 12A1 and the first signal electrode 12B1, and a third EO polymer 13C that is inserted into the opening portion 33A1. The first waveguide 11C1 is in a state in which a part of the third EO polymer 13C is inserted into the slot 15B.

The third region 20C on the second waveguide 11C2 side includes the second ground electrode 12A2, the second signal electrode 12B2, and the third ground electrode 12A3. The third region 20C on the second waveguide 11C2 side includes the opening portion 33A1 that is formed in the buffer layer 33 located between the third ground electrode 12A3 and the second signal electrode 12B2, and the third EO polymer 13C that is inserted into the opening portion 33A1. The second waveguide 11C2 is in a state in which a part of the third EO polymer 13C is inserted into the slot 15B.

FIG. 4 is a schematic cross-sectional diagram taken along line B-B illustrated in FIG. 2. The schematic cross-sectional region taken along the line B-B illustrated in FIG. 4 is the first boundary region 21A located on, for example, the first waveguide 11C1 side. The first boundary region 21A corresponds to a boundary region located between the first region 20A and the second region 20B, i.e., a region that splits a portion between the first EO polymer 13A and the second EO polymer 13B. The first boundary region 21A includes the first waveguide 11C1 that joins a portion between the first waveguide 11C1 located in the first region 20A and the first waveguide 11C1 located in the second region 20B.

The first boundary region 21A on the first waveguide 11C1 side includes the first ground electrode 12A1, the first signal electrode 12B1, and the second ground electrode 12A2. The first boundary region 21A on the first waveguide 11C1 side includes a first bridge 14A (14) that electrically connects a portion between the first ground electrode 12A1 and the second ground electrode 12A2. The first waveguide 11C1 included in the first boundary region 21A on the first waveguide 11C1 side is constituted of the two pieces of N doped Si 15A, but is in a state in which no EO polymer is present in the slot 15B. the first bridge 14A included in the first boundary region 21A on the first waveguide 11C1 side electrically connects the region 12A11 located in the first layer M1 included in the first ground electrode 12A1 and the region 12A21 located in the first layer M1 included in the second ground electrode 12A2. The first signal electrode 12B1 included in the first boundary region 21A on the first waveguide 11C1 side only includes the region 12B12 located in the second layer M2, and is in a state in which the region in the first layer M1 located in the first signal electrode 12B1 is not present.

The first boundary region 21A on the second waveguide 11C2 side includes the second ground electrode 12A2, the second signal electrode 12B2, and the third ground electrode 12A3. The first boundary region 21A on the second waveguide 11C2 side includes the first bridge 14A (14) that electrically connects a portion between the second ground electrode 12A2 and the third ground electrode 12A3. the second waveguide 11C2 included in the first boundary region 21A on the second waveguide 11C2 side is constituted of the two pieces of N doped Si 15A, but is in a state in which no EO polymer is present in the slot 15B. The first bridge 14A included in the first boundary region 21A on the second waveguide 11C2 side electrically connects the region 12A21 located in the first layer M1 included in the second ground electrode 12A2 and a region 12A31 located in the first layer M1 included in the third ground electrode 12A3. The second signal electrode 12B2 included in the first boundary region 21A on the second waveguide 11C2 side only includes a region 12B22 located in the second layer M2, and is in a state in which the region in the first layer M1 located in the second signal electrode 12B2 is not present.

The second boundary region 21B corresponds to a boundary region located between the second region 20B and the third region 20C, that is, a region that splits a portion between the second EO polymer 13B and the third EO polymer 13C. The second boundary region 21B includes the first waveguide 11C1 that joins a portion between the first waveguide 11C1 located in the second region 20B and the first waveguide 11C1 located in the third region 20C. Furthermore, the second boundary region 21B includes the second waveguide 11C2 that joins a portion between the second waveguide 11C2 located in the second region 20B and the second waveguide 11C2 located in the third region 20C.

The second boundary region 21B on the first waveguide 11C1 side includes the first ground electrode 12A1, the first signal electrode 12B1, and the second ground electrode 12A2. The second boundary region 21B on the first waveguide 11C1 side includes the first bridge 14A (14) that electrically connects a portion between the first ground electrode 12A1 and the second ground electrode 12A2. The first waveguide 11C1 included in the second boundary region 21B on the first waveguide 11C1 side is constituted of the two pieces of N doped Si 15A, but is in a state in which no EO polymer is present in the slot 15B. The first bridge 14A included in the second boundary region 21B on the first waveguide 11C1 side electrically connects the region 12A11 located in the first layer M1 included in the first ground electrode 12A1 and the region 12A21 located in the first layer M1 included in the second ground electrode 12A2. Furthermore, the first signal electrode 12B1 included in the second boundary region 21B on the first waveguide 11C1 side only includes the region 12B12 located in the second layer M2. A portion between the region 12B12 and the N doped Si 15A provided in the first waveguide 11C1 is connected by the via 16. The first signal electrode 12B1 included in the second boundary region 21B on the first waveguide 11C1 side only includes the region 12B12 located in the second layer M2, and is in a state in which the region in the first layer M1 located in the first signal electrode 12B1 is not present.

The second boundary region 21B on the second waveguide 11C2 side includes the second ground electrode 12A2, the second signal electrode 12B2, and the third ground electrode 12A3. The second boundary region 21B on the second waveguide 11C2 side includes the first bridge 14A (14) that electrically connects a portion between the second ground electrode 12A2 and the third ground electrode 12A3. The second waveguide 11C2 included in the second boundary region 21B on the second waveguide 11C2 side is constituted of the two pieces of N doped Si 15A, but is in a state in which no EO polymer is present in the slot 15B. The first bridge 14A included in the second boundary region 21B on the second waveguide 11C2 side electrically connects the region 12A21 located in the first layer M1 included in the second ground electrode 12A2 and the region 12A31 located in the first layer M1 included in the third ground electrode 12A3. Furthermore, the second signal electrode 12B2 included in the second boundary region 21B on the second waveguide 11C2 side only includes the region 12B22 located in the second layer M2. A portion between the region 12B22 and the N doped Si 15A included in the second waveguide 11C2 is connected by the via 16. The second signal electrode 12B2 included in the second boundary region 21B on the second waveguide 11C2 side only includes the region 12B22 located in the second layer M2, and is in a state in which the region of the first layer M1 located in the second signal electrode 12B2 is not present.

The first waveguide 11C1 included in the optical modulator 5 changes the phase of the propagating light as a result of a change in the refractive index in accordance with the drive voltage of a high-frequency signal applied to the first signal electrode 12B1 included in the first region 20A, the second region 20B, and the third region 20C. Furthermore, the first waveguide 11C1 electrically connects, by using the first bridge 14A, a portion between the first ground electrode 12A1 and the second ground electrode 12A2 included in the first boundary region 21A and the second boundary region 21B. The electric potentials between the first ground electrode 12A1 and the second ground electrode 12A2 are stabilized by equalizing the electric potentials as a result of the electric current flowing between the first ground electrode 12A1 and the second ground electrode 12A2. Consequently, the electric potentials between the first ground electrode 12A1 and the second ground electrode 12A2 are stabilized, and it is thus possible to suppress a decrease in the high-frequency drive voltage between the first signal electrode 12B1 and the first ground electrode 12A1. As a result, it is possible to increase in a high frequency band without reducing the modulation efficiency at a high frequency.

The second waveguide 11C2 included in the optical modulator 5 changes the phase of the propagating light as a result of a change in the refractive index in accordance with the drive voltage of a high-frequency signal applied to the second signal electrode 12B2 included in the first region 20A, the second region 20B, and the third region 20C. Furthermore, the second waveguide 11C2 electrically connects, by using the first bridge 14A, a portion between the third ground electrode 12A3 and the second ground electrode 12A2 included in the first boundary region 21A and the second boundary region 21B. The electric potentials between the second ground electrode 12A2 and the third ground electrode 12A3 are stabilized by equalizing the electric potentials as a result of the electric current flowing between the second ground electrode 12A2 and the third ground electrode 12A3. Consequently, the electric potentials between the third ground electrode 12A3 and the second ground electrode 12A2 are stabilized, and it is thus possible to suppress a decrease in the high-frequency drive voltage between the second signal electrode 12B2 and the third ground electrode 12A3. As a result, it is possible to increase in a high frequency band without reducing the modulation efficiency at a high frequency.

In the optical modulator 5 according to the first embodiment, it is effective to electrically connects, by using the first bridge 14A, the ground electrodes located at both sides at a distance between the signal electrode and the ground electrode, such as at an interval of several 100 μm to several mm. That is, the electric potentials are equalized by electrically connecting a portion between the ground electrodes located at both sides by using the first bridge 14A at a position at which an electrical signal has propagated some distance, and allowing the electric current to flow between the ground electrodes. When the electric potentials between the ground electrodes located at both sides of the signal electrode become stable, a decrease in the voltage between the signal electrode and the ground electrode at a high frequency is suppressed. As a result, it is possible to increase in a high frequency band without reducing the modulation efficiency at a high frequency.

Furthermore, a case has been described as an example in which, in the optical modulator 5 according to the first embodiment, the EO polymer 13 is disposed by inserting an EO polymer into each of the opening portions 33A1 in the first region 20A, the second region 20B, and the third region 20C by using a dispenser. However, an operation for inserting the EO polymer into each of the split opening portions 33A1 by using the dispenser becomes complicated. Accordingly, when an EO polymer is inserted into the first region 20A, the first boundary region 21A, the second region 20B, the second boundary region 21B, and the third region 20C by using the dispenser, the operation thereof is easy even if the opening portions 33A1 are in a split state. Therefore, an embodiment of the optical modulator 5 manufactured by using this manufacturing method will be described as a second embodiment.

### [b] Second Embodiment

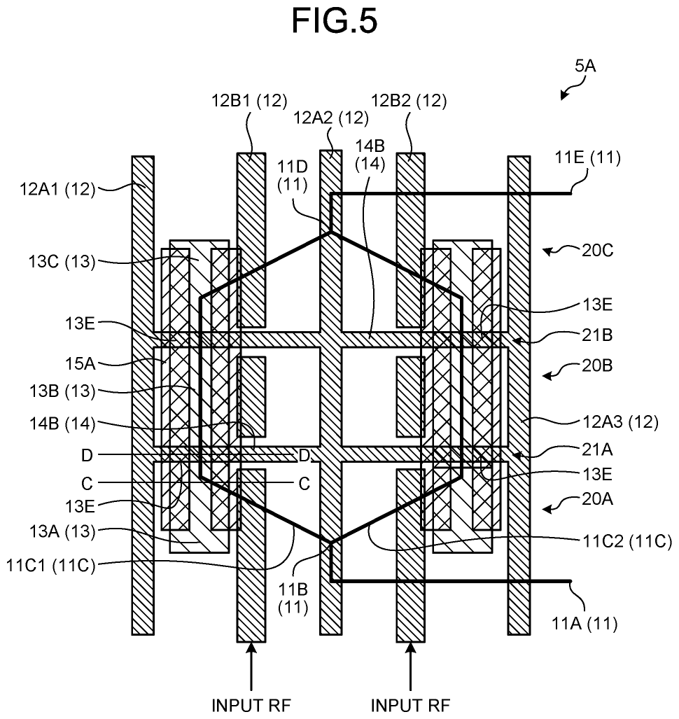

FIG. 5 is a schematic plan view illustrating an example of a configuration of an optical modulator 5A according to the second embodiment. In addition, by assigning the same reference numerals to components having the same configuration as those in the optical modulator 5 according to the first embodiment, overlapped descriptions of the configuration and the operation thereof will be omitted. The optical modulator 5A illustrated in FIG. 5 is different from the optical modulator 5 illustrated in FIG. 2 in that an EO polymer 13E is disposed on the surface of the buffer layer 33 included in the first boundary region 21A and the second boundary region 21B. Furthermore, the optical modulator 5A illustrated in FIG. 5 is different from the optical modulator 5 illustrated in FIG. 2 in that the bridge 14 included in each of the first boundary region 21A and the second boundary region 21B is formed in the second layer M2 instead of the first layer M1.

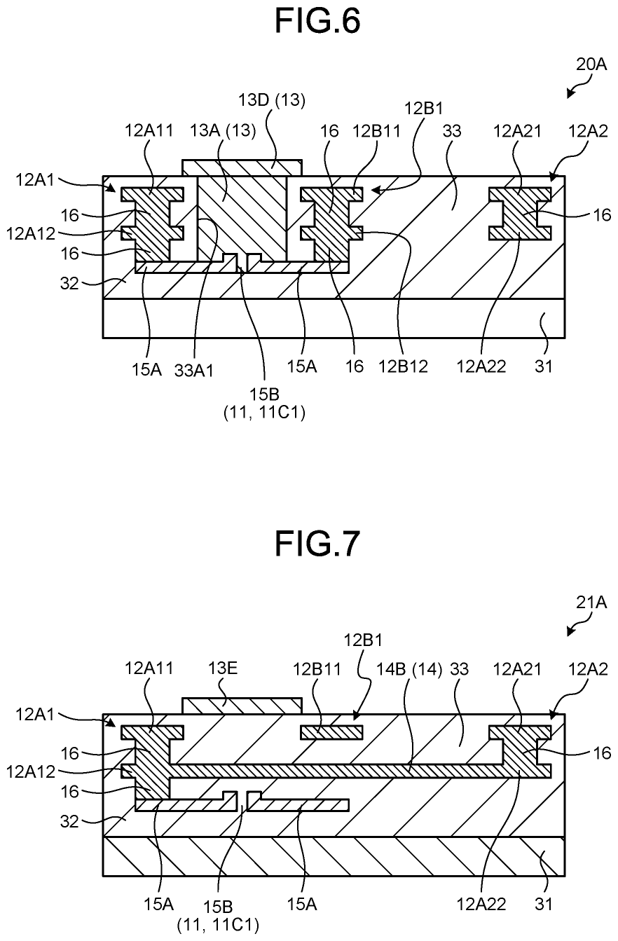

FIG. 6 is a schematic cross-sectional diagram taken along line C-C illustrated in FIG. 5, and FIG. 7 is a schematic cross-sectional diagram taken along line D-D illustrated in FIG. 5. An EO polymer 13D located on the surface of the buffer layer 33 included in the first region 20A illustrated in FIG. 6 is structured to be flush with the EO polymer 13E located on the surface of the buffer layer 33 included in the first boundary region 21A illustrated in FIG. 7. In addition, the second region 20B and the third region 20C have the same configuration as that of the first region 20A, and the second boundary region 21B has the same configuration as that of the first boundary region 21A.

That is, the EO polymer 13D located on the surface of the buffer layer 33 included in the first region 20A, the second region 20B, and the third region 20C is structured to be flush with the EO polymer 13E located on the surface of the buffer layer 33 included in the first boundary region 21A and the second boundary region 21B.

The first boundary region 21A on the first waveguide 11C1 side illustrated in FIG. 7 includes a second bridge 14B that electrically connects the region 12A12 located in the second layer M2 included in the first ground electrode 12A1 and the region 12A22 located in the second layer M2 included in the second ground electrode 12A2. The first signal electrode 12B1 included in the first boundary region 21A on the first waveguide 11C1 side only includes the region 12B11 located in the first layer M1, and is in a state in which the region in the second layer M2 located in the first signal electrode 12B1 is not present.

The first boundary region 21A on the second waveguide 11C2 side includes the second bridge 14B that electrically connects a region 12A32 located in the second layer M2 included in the third ground electrode 12A3 and the region 12A22 located in the second layer M2 included in the second ground electrode 12A2. The second signal electrode 12B2 included in the first boundary region 21A on the second waveguide 11C2 side only includes a region 12B21 located in the first layer M1, and is in a state in which the region in the second layer M2 included in the second signal electrode 12B2 is not present.

The second boundary region 21B on the first waveguide 11C1 side includes the second bridge 14B that electrically connects the region 12A12 located in the second layer M2 included in the first ground electrode 12A1 and the region 12A22 located in the second layer M2 included in the second ground electrode 12A2. The first signal electrode 12B1 included in the second boundary region 21B on the first waveguide 11C1 side only includes the region 12B11 located in the first layer M1, and is in a state in which the region in the second layer M2 included in the first signal electrode 12B1 is not present.

The second boundary region 21B on the second waveguide 11C2 side includes the second bridge 14B that electrically connects the region 12A32 located in the second layer M2 included in the third ground electrode 12A3 and the region 12A22 located in the second layer M2 included in the second ground electrode 12A2. The second signal electrode 12B2 included in the second boundary region 21B on the second waveguide 11C2 side only includes the region 12B21 located in the first layer M1, and is in a state in which the region in the second layer M2 included in the second signal electrode 12B2 is not present.

In the optical modulator 5A according to the second embodiment, the EO polymer 13 is inserted into each of the opening portions 33A1 included in the first region 20A, the second region 20B, and the third region 20C while allowing the EO polymer to be applied on the surface of the first boundary region 21A and the second boundary region 21B. Consequently, an operation process for inserting an EO polymer performed by using a dispenser becomes easy.

The first waveguide 11C1 electrically connects, by using the second bridge 14B, the second layer M2 located between the first ground electrode 12A1 and the second ground electrode 12A2 included in the first boundary region 21A and the second boundary region 21B. Consequently, the electric potentials between the first ground electrode 12A1 and the second ground electrode 12A2 become stable, so that it is possible to stabilize a high-frequency drive voltage between the first signal electrode 12B1 and the first ground electrode 12A1. Furthermore, the second layer M2 is closer to the first waveguide 11C1 than the first layer M1, and an electric current flows in the vicinity of the first waveguide 11C1, so that, in the second bridge 14B, the efficiency of the electric field acting on the first waveguide 11C1 is increased.

The second waveguide 11C2 electrically connects, by using the second bridge 14B, the second layer M2 located between the third ground electrode 12A3 and the second ground electrode 12A2 included in the first boundary region 21A and the second boundary region 21B. As a result, the electric potentials between the third ground electrode 12A3 and the second ground electrode 12A2 become stable, so that it is possible to stabilize a high-frequency drive voltage between the second signal electrode 12B2 and the third ground electrode 12A3. Furthermore, the second layer M2 is closer to the second waveguide 11C2 than the first layer M1, and an electric current flows in the vicinity of the second waveguide 11C2, so that, in the second bridge 14B, the efficiency of the electric field acting on the second waveguide 11C2 is increased.

### [c] Third Embodiment

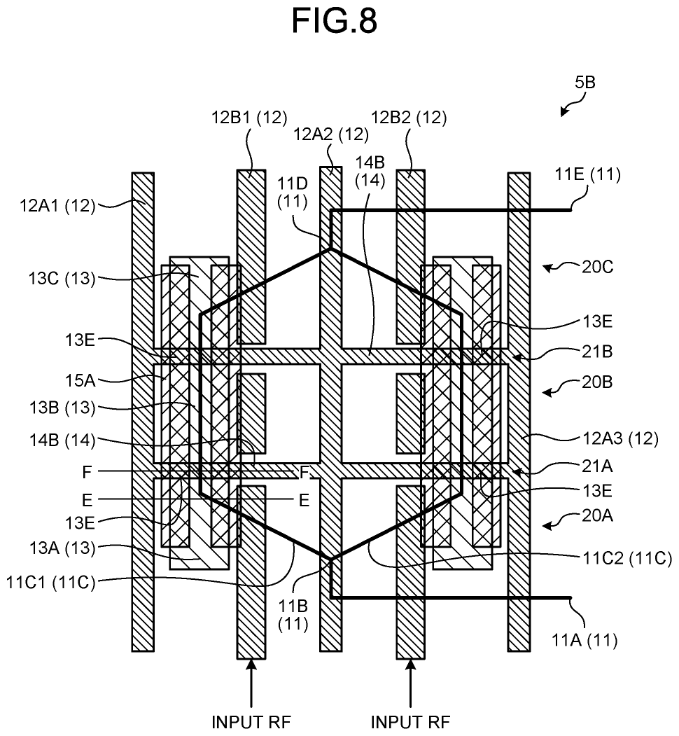

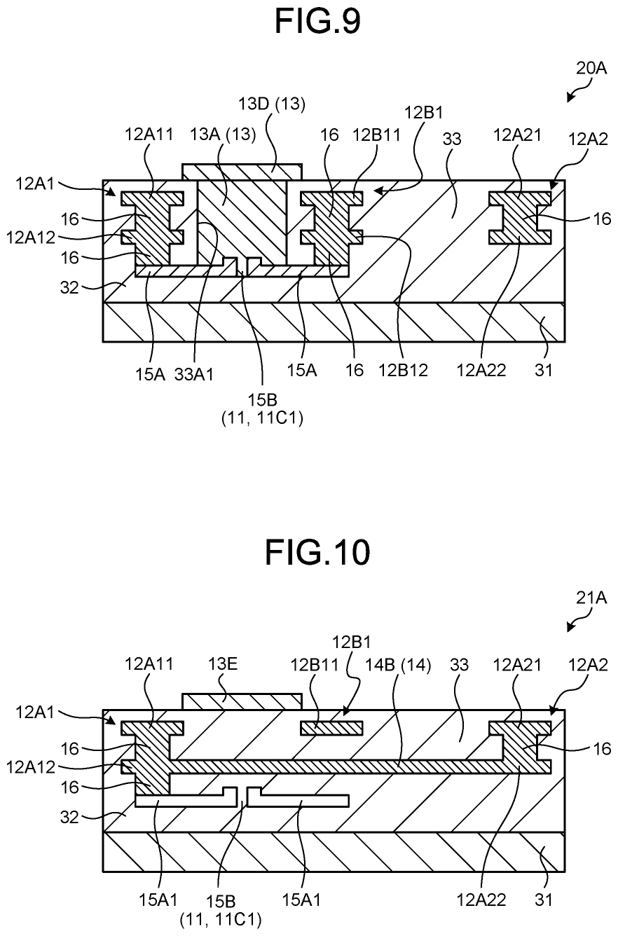

FIG. 8 is a schematic plan view illustrating an example of a configuration of an optical modulator 5B according to a third embodiment, FIG. 9 is a schematic cross-sectional diagram taken along line E-E illustrated in FIG. 8, and FIG. 10 is a schematic cross-sectional diagram taken along line F-F illustrated in FIG. 8. In addition, by assigning the same reference numerals to components having the same configuration as those in the optical modulator 5A according to the second embodiment, overlapped descriptions of the configuration and the operation thereof will be omitted.

The optical modulator 5B according to the third embodiment is different from the optical modulator 5A according to the second embodiment in that the waveguide 11C included in each of the first boundary region 21A and the second boundary region 21B is constituted of undoped Si 15A1.

The first boundary region 21A and the second boundary region 21B are in a state without an EO polymer. The first waveguide 11C1 included in the first boundary region 21A is a portion that does not contribute to modulation even if an electric field is applied, so that the first waveguide 11C1 is constituted as a waveguide that includes a slot 15B1 between the two pieces of undoped Si 15A1. The second waveguide 11C2 included in the first boundary region 21A is also a portion that does not contribute to modulation even if an electric field is applied, so that the second waveguide 11C2 is constituted as a waveguide that includes the slot 15B1 between the two pieces of undoped Si 15A1.

The first waveguide 11C1 included in the second boundary region 21B is also a portion that does not contribute to modulation even if an electric field is applied, so that the first waveguide 11C1 is constituted as a waveguide that includes the slot 15B1 between the two pieces of undoped Si 15A1. The second waveguide 11C2 included in the second boundary region 21B is also a portion that does not contribute to modulation even if an electric field is applied, so that the second waveguide 11C2 is constituted as a waveguide that includes the slot 15B1 between the two pieces of undoped Si 15A1.

In the optical modulator 5B according to the third embodiment, the first waveguide 11C1 and the second waveguide 11C2 included in the first boundary region 21A and the second boundary region 21B are constituted of the undoped Si. Consequently, in the first boundary region 21A and the second boundary region 21B, it is possible to reduce absorption of light caused by dopant and it is thus possible to decrease a loss of light.

### [d] Fourth Embodiment

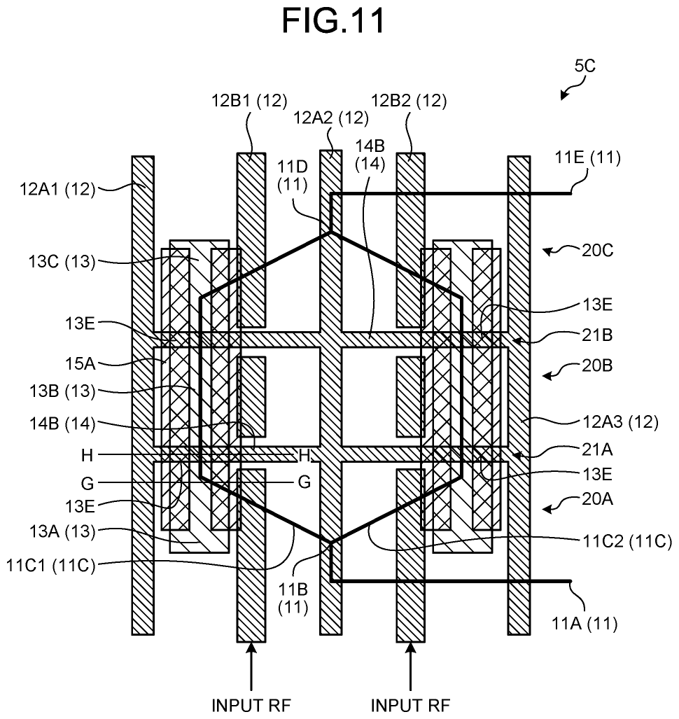

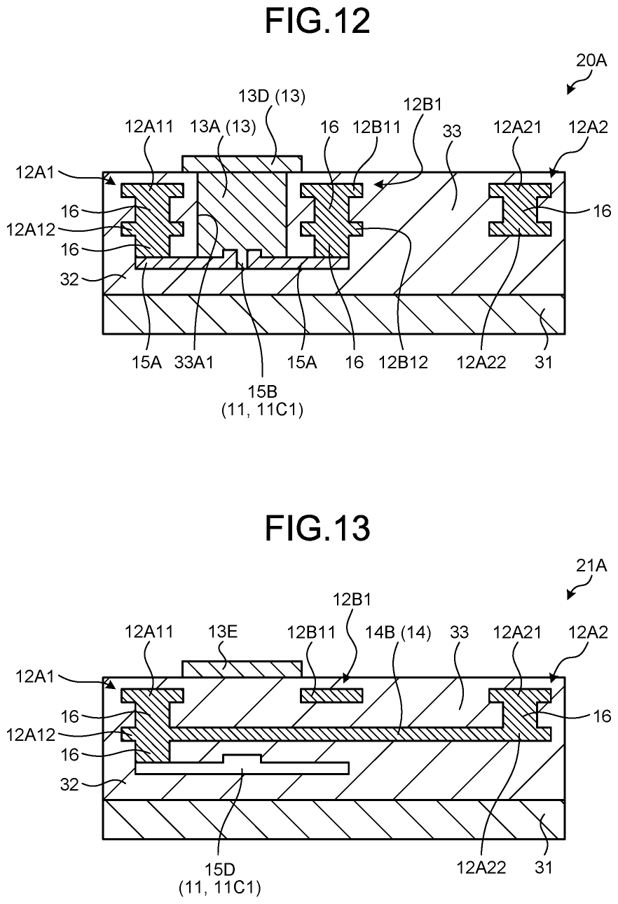

FIG. 11 is a schematic plan view illustrating an example of a configuration of an optical modulator 5C according to a fourth embodiment, FIG. 12 is a schematic cross-sectional diagram taken along line G-G illustrated in FIG. 11, and FIG. 13 is a schematic cross-sectional diagram taken along line H-H illustrated in FIG. 11. In addition, by assigning the same reference numerals to components having the same configuration as those in the optical modulator 5B according to the third embodiment, overlapped descriptions of the configuration and the operation thereof will be omitted.

The optical modulator 5C according to the fourth embodiment is different from the optical modulator 5B according to the third embodiment in that the waveguide 11C included in each of the first boundary region 21A and the second boundary region 21B is constituted by a rib waveguide 15D instead of the slot waveguide.

The first waveguide 11C1 included in the first boundary region 21A is the rib waveguide 15D that does not include a slot and that is constituted of the undoped Si 15A1. The second waveguide 11C2 included in the first boundary region 21A is the rib waveguide 15D that does not include a slot and that is constituted of the undoped Si 15A1.

The first waveguide 11C1 included in the second boundary region 21B is the rib waveguide 15D that does not include a slot and that is constituted of the undoped Si 15A1. The second waveguide 11C2 included in the second boundary region 21B is the rib waveguide 15D that does not include a slot and that is constituted of the undoped Si 15A1.

In the optical modulator 5C according to the fourth embodiment, the first waveguide 11C1 and the second waveguide 11C2 included in the first boundary region 21A and the second boundary region 21B are constituted by the rib waveguide 15D that is constituted of the undoped Si. Consequently, it is possible to decrease a loss of light as a result of the slot being present at the center of the optical waveguide.

In addition, in the optical modulator 5 according to the first embodiment to the fourth embodiment described above, a case has been described as an example of the optical modulator that has a GSG structure and that includes the first ground electrode 12A1, the first signal electrode 12B1, the second ground electrode 12A2, the second signal electrode 12B2, and the third ground electrode 12A3. However, the example is not limited to this structure, and appropriate modifications are possible. Accordingly, an embodiment thereof will be described as a fifth embodiment. In addition, by assigning the same reference numerals to components having the same configuration as those in the optical modulator 5A according to the second embodiment, overlapped descriptions of the configuration and the operation thereof will be omitted.

### [e] Fifth Embodiment

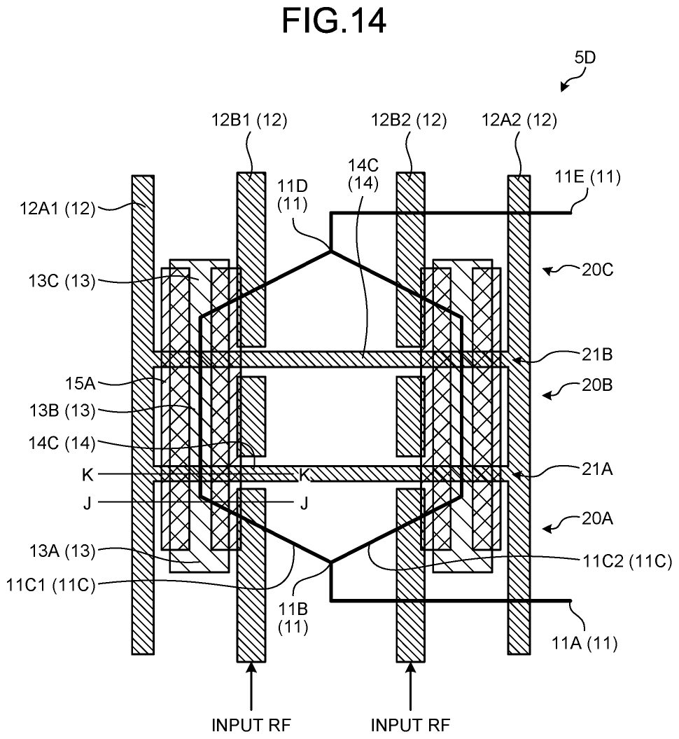

FIG. 14 is a schematic plan view illustrating an example of a configuration of an optical modulator 5D according to the fifth embodiment. The electrode 12 included in the optical modulator 5D illustrated in FIG. 14 has a GSSG structure including the first ground electrode 12A1, the first signal electrode 12B1, the second signal electrode 12B2, and the second ground electrode 12A2.

The electrode 12 is an electrode that has a coplanar structure including the first ground electrode 12A1, the first signal electrode 12B1, the second ground electrode 12A2, and the second signal electrode 12B2. The first signal electrode 12B1 is disposed so as to be parallel to the first ground electrode 12A1. The second signal electrode 12B2 is disposed so as to be parallel to the second ground electrode 12A2.

Between the two waveguides 11C, the first waveguide 11C1 is an optical waveguide that is disposed between the first ground electrode 12A1 and the first signal electrode 12B1. The first waveguide 11C1 is a slot waveguide that includes the slot 15B constituted of the two pieces of N doped Si 15A.

Between the two waveguides 11C, the second waveguide 11C2 is an optical waveguide that is disposed between the second signal electrode 12B2 and the second ground electrode 12A2. The second waveguide 11C2 is a slot waveguide that includes the slot 15B constituted of the two pieces of N doped Si 15A.

The optical modulator 5D includes the first region 20A that is located in the travelling direction of light passing through the optical waveguide 11, the second region 20B that is located in the travelling direction of light passing through the optical waveguide 11, and the third region 20C that is located in the travelling direction of light passing through the optical waveguide 11. The optical modulator 5D includes the first boundary region 21A located between the first region 20A and the second region 20B, and the second boundary region 21B located between the second region 20B and the third region 20C.

In the optical modulator 5D, in accordance with the travelling direction of the light passing through the optical waveguide 11, the light passes through the waveguide 11C from the first region 20A toward the first boundary region 21A, the second region 20B, the second boundary region 21B, and the third region 20C in this order.

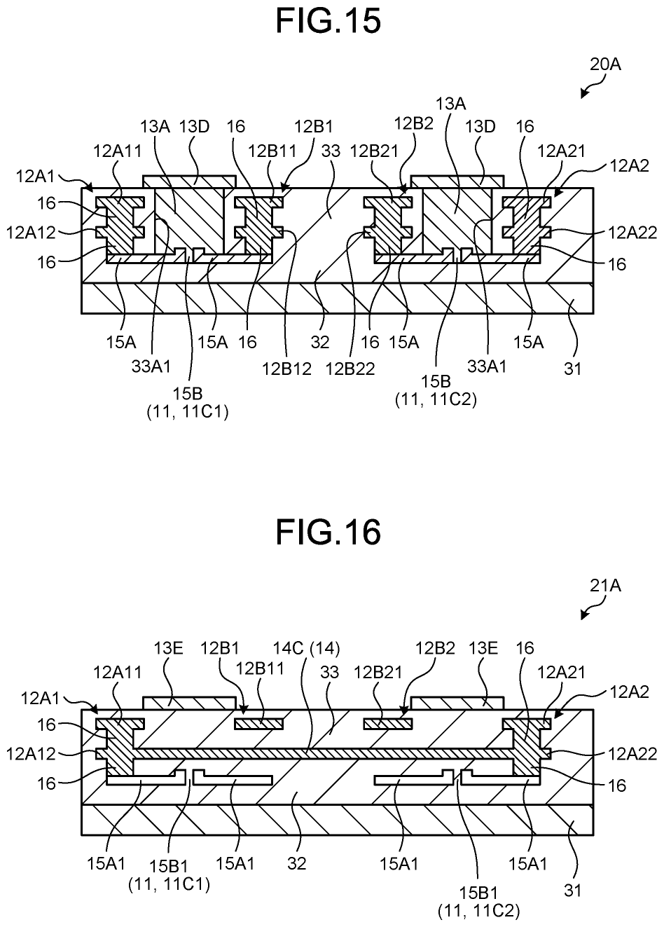

FIG. 15 is a schematic cross-sectional diagram taken along line J-J illustrated in FIG. 14. The schematic cross-sectional region taken along line J-J illustrated in FIG. 15 is, for example, the first region 20A. The first region 20A includes the silicon substrate 31, the intermediate layer 32 that is made of SiO₂ and that is laminated on the silicon substrate 31, the optical waveguide 11 that is formed on the intermediate layer 32, the buffer layer 33 that is made of SiO₂ and that is laminated on the intermediate layer 32 including the optical waveguide 11, and the electrode 12. In addition, the electrode 12 includes the first ground electrode 12A1, the first signal electrode 12B1, the second signal electrode 12B2, and the second ground electrode 12A2.

The first ground electrode 12A1 includes the region 12A11 located in the first layer M1, and the region 12A12 located in the second layer M2. The first signal electrode 12B1 includes the region 12B11 located in the first layer M1, and the region 12B12 located in the second layer M2.

A portion between the region 12A11 located in the first layer M1 included in the first ground electrode 12A1 and the region 12A12 located in the second layer M2 included in the first ground electrode 12A1 is joined by the via 16, and a portion between the region 12A12 located in the second layer M2 included in the first ground electrode 12A1 and the N doped Si 15A is joined by the via 16. A portion between the region 12B11 located in the first layer M1 included in the first signal electrode 12B1 and the region 12B12 located in the second layer M2 included in the first signal electrode 12B1 is joined by the via 16, and a portion between the region 12B12 located in the second layer M2 included in the first signal electrode 12B1 and the N doped Si 15A is joined by the via 16. A portion between the region 12A21 located in the first layer M1 included in the second ground electrode 12A2 and the region 12A22 located in the second layer M included in the second ground electrode 12A2 is joined by the via 16.

The first region 20A includes the first EO polymer 13A inserted into the opening portion 33A1 included in the buffer layer 33, and the first waveguide 11C1 that is constituted such that a part of the first EO polymer 13A is inserted into the slot 15B.

The first region 20A on the first waveguide 11C1 side includes the first ground electrode 12A1 and the first signal electrode 12B1, and is in a state in which the first EO polymer 13A is disposed in the opening portion 33A1 that is formed in the buffer layer 33 and that is located between the first ground electrode 12A1 and the first signal electrode 12B1. A part of the first EO polymer 13A is inserted into the slot 15B provided in the first waveguide 11C1.

The first region 20A on the second waveguide 11C2 side includes the second signal electrode 12B2 and the second ground electrode 12A2, and is in a state in which the first EO polymer 13A is disposed in the opening portion 33A1 that is formed in the buffer layer 33 and that is located between the second ground electrode 12A2 and the second signal electrode 12B2. A part of the first EO polymer 13A is inserted in the slot 15B included in the second waveguide 11C2.

The configuration of each of the second region 20B and the third region 20C is also substantially the same as that of the first region 20A; therefore, by assigning the same reference numerals to components having the same configuration as those in the first region 20A, overlapped descriptions of the configuration and the operation thereof will be omitted. The second region 20B includes the second EO polymer 13B that is inserted into the opening portion 33A1 located in the buffer layer 33, and the first waveguide 11C1 and the second waveguide 11C2 each of which is constituted such that a part of the second EO polymer 13B is inserted into the slot 15B.

The third region 20C also includes the third EO polymer 13C that is inserted into the opening portion 33A1 located in the buffer layer 33, and the first waveguide 11C1 and the second waveguide 11C2 each of which is constituted such that a part of the third EO polymer 13C is inserted into the slot 15B.

FIG. 16 is a schematic cross-sectional diagram taken along line K-K illustrated in FIG. 14. The schematic cross-sectional region taken along line K-K illustrated in FIG. 16 is, for example, the first boundary region 21A. The first boundary region 21A corresponds to boundary region located between the first region 20A and the second region 20B, that is, a region that splits a portion between the first EO polymer 13A and the second EO polymer 13B. The first boundary region 21A includes the first waveguide 11C1 that joins a portion between the first waveguide 11C1 located in the first region 20A and the first waveguide 11C1 located in the second region 20B. The first boundary region 21A includes a third bridge 14C (14) that electrically connects a portion between the first ground electrode 12A1 and the second ground electrode 12A2.

The first boundary region 21A on the first waveguide 11C1 side includes the first ground electrode 12A1 and the first signal electrode 12B1. The first waveguide 11C1 is constituted of the two pieces of N undoped Si 15A1, and is in a state in which no EO polymer is present in the slot 15B1. The first boundary region 21A on the second waveguide 11C2 side includes the second signal electrode 12B2 and the second ground electrode 12A2. The second waveguide 11C2 is also constituted of the two pieces of N undoped Si 15A1, and is in a state in which no EO polymer is present in the slot 15B1.

The third bridge 14C electrically connects the region 12A12 that is located in the second layer M2 included in the first ground electrode 12A1 and the region 12A22 that is located in the second layer M2 included in the second ground electrode 12A2.

In the above, the configuration of the first boundary region 21A has been described. The configuration of the second boundary region 21B is substantially the same as that of the first boundary region 21A; therefore, by assigning the same reference numerals to components having the same configuration as those in the first boundary region 21A, overlapped descriptions of the configuration and the operation thereof will be omitted. The second boundary region 21B corresponds to a boundary region located between the second region 20B and the third region 20C, that is, a region that splits a portion between the second EO polymer 13B and the third EO polymer 13C. The second boundary region 21B includes the first waveguide 11C1 that joins a portion between the first waveguide 11C1 located in the second region 20B and the first waveguide 11C1 located in the third region 20C. The second boundary region 21B includes the second waveguide 11C2 that joins a portion between the second waveguide 11C2 located in the second region 20B and the second waveguide 11C2 located in the third region 20C. The second boundary region 21B includes the third bridge 14C (14) that electrically connects the second layer M2 located between the first ground electrode 12A1 and the second ground electrode 12A2. The third bridge 14C electrically connects the region 12A12 that is located in the second layer M2 included in the first ground electrode 12A1 and the region 12A22 that is located in the second layer M2 included in the second ground electrode 12A2.

The first waveguide 11C1 included in the optical modulator 5D changes the phase of the propagating light as a result of a change in the refractive index in accordance with the drive voltage of a high-frequency signal applied to the first signal electrode 12B1 included in the first region 20A, the second region 20B, and the third region 20C. The second waveguide 11C2 included in the optical modulator 5D changes the phase of the propagating light as a result of a change in the refractive index in accordance with the drive voltage of a high-frequency signal applied to the second signal electrode 12B2 included in the first region 20A, the second region 20B, and the third region 20C. Furthermore, the first waveguide 11C1 and the second waveguide 11C2 electrically connects, by using the third bridge 14C, a portion between the first ground electrode 12A1 and the second ground electrode 12A2 included in the first boundary region 21A and the second boundary region 21B. Consequently, even if the optical modulator 5D has a GSSG structure, the electric potentials between the first ground electrode 12A1 and the second ground electrode 12A2 are stabilized, so that it is possible to stabilize the high-frequency drive voltage between the first signal electrode 12B1 and the first ground electrode 12A1.

In addition, a case has been described as an example in which the optical modulator 5 according to the first embodiment described above has a GSG structure that includes three ground electrodes and two signal electrodes; however, the number of ground electrodes and signal electrodes is not limited to this, and appropriate modifications are possible.

A case has been described as an example in which, in the optical modulator 5, the first region 20A, the first boundary region 21A, the second region 20B, the second boundary region 21B, and the third region 20C are sequentially disposed in this order in the travelling direction of light passing through the optical waveguide 11, and the two boundary regions 21A and 21B are disposed. However, the number of boundary regions is not limited to two as long as one or more boundary regions is used, and appropriate modifications are possible.

In addition, a case has been described as an example in which the electrode 12 included in the optical modulator 5 is constituted of two layers, i.e., the first layer M1 and the second layer M2; however, three layers may be used. In a case of three layers, the bridge 14 that electrically connects the ground electrodes may be provided by using at least one or more layers, and appropriate modifications are possible.

According to an aspect of an embodiment of the optical device and the like disclosed in the present application, modulation efficiency is improved while suppressing electric power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a slot waveguide;
an electrode that has a coplanar structure including a signal electrode and a ground electrode disposed parallel to the slot waveguide;
a plurality of electro-optical polymers each of which is inserted into a slot provided in the slot waveguide in a split state; and
a bridge that is disposed in a boundary region located between the split electro-optical polymers and that electrically connects the ground electrode and another ground electrode.

2. The optical device according to claim 1, wherein a drive voltage applied to the signal electrode is a high-frequency signal.

3. The optical device according to claim 2, wherein
the electrode includes
a first layer, and
a second layer that is disposed at a lower portion of the first layer, and
the bridge electrically connects the first layer included in the ground electrode and the first layer included in the other ground electrode.

4. The optical device according to claim 2, wherein
the electrode includes
a first layer, and
a second layer that is disposed at a lower portion of the first layer, and
the bridge electrically connects the second layer included in the ground electrode and the second layer in the other ground electrode.

5. The optical device according to claim 1, wherein
the optical device includes
a first region that is located in a travelling direction of light passing through the slot waveguide,
a second region that is located in the travelling direction of light passing through the slot optical waveguide, and
the boundary region located between the first region and the second region, and
the boundary region is a region that splits a portion between a first electro-optical polymer that is disposed at an opening portion included in the first region and that is inserted into the slot provided in the slot waveguide and a second electro-optical polymer that is disposed at an opening portion included in the second region and that is inserted into the slot provided in the slot waveguide.

6. The optical device according to claim 5, wherein
the electrode includes
a first layer, and
a second layer that is disposed at a lower portion of the first layer, and
the electro-optical polymer is disposed on a surface of each of the first region, the second region, and the boundary region by inserting the electro-optical polymer into
the opening portion included in a buffer layer that covers the first layer located in the first region, and
the opening portion included in the buffer layer that covers the first layer located in the second region, and by inserting the electro-optical polymer on a top surface of the buffer layer that covers the first layer located in the boundary region.

7. The optical device according to claim 6, wherein
the slot waveguide included in each of the first region and the second region is constituted of doped silicon, and
the slot waveguide included in the boundary region is constituted of undoped silicon.

8. The optical device according to claim 7, wherein the slot waveguide located in the boundary region is constituted of a rib waveguide instead of the slot waveguide.

9. The optical device according to claim 5, wherein
the electrode includes
a first ground electrode,
a first signal electrode that is disposed in a state parallel to the first ground electrode, and
a second ground electrode that is disposed in a state parallel to the first signal electrode, and
in the first region and the second region, the slot waveguide is disposed between the first ground electrode and the first signal electrode, and
the bridge disposed in the boundary region includes a bridge that electrically connects a portion between the first ground electrode and the second ground electrode.

10. The optical device according to claim 5, wherein
the electrode includes
a first ground electrode,
a first signal electrode that is disposed in a state parallel to the first ground electrode,
a second signal electrode that is disposed in a state parallel to the first signal electrode, and
a second ground electrode that is disposed in a state parallel to the second signal electrode, and
in the first region and the second region,
the slot waveguide is disposed between the first ground electrode and the first signal electrode, and
the slot waveguide is disposed between the second signal electrode and the second ground electrode are disposed, and
the bridge disposed in the boundary region includes a bridge that electrically connects a portion between the first ground electrode and the second ground electrode.

11. An optical modulator that comprises
a slot waveguide, and
an electrode that has a coplanar structure including a signal electrode and a ground electrode disposed parallel to the slot waveguide, and that varies a refractive index in the slot waveguide in accordance with a drive voltage applied to the signal electrode, the optical modulator including:
a plurality of electro-optical polymers each of which is inserted into a slot provided in the slot waveguide in a split state; and
a bridge that is disposed in a boundary region located between the split electro-optical polymers and that electrically connects the ground electrode and another ground electrode.

12. An optical communication apparatus comprising:
a processor that executes signal processing on an electrical signal;
a light source that emits light; and
an optical modulator that modulates the light emitted from the light source by using an electrical signal that is output from the processor, wherein
the optical modulator includes
a slot waveguide, and
an electrode that has a coplanar structure including a signal electrode and a ground electrode disposed parallel to the slot waveguide, and that varies a refractive index in the slot waveguide in accordance with a drive voltage applied to the signal electrode, wherein the optical modulator includes
a plurality of electro-optical polymers each of which is inserted into a slot provided in the slot waveguide in a split state; and
a bridge that is disposed in a boundary region located between the split electro-optical polymers and that electrically connects the ground electrode and another ground electrode.
